(19) United States
(12) Patent Application Publication
(10) Pub. No.: US 2011/0120276 A1
(43) Pub. Date: May 26, 2011

(54) Light Bulb Changer

(76) Inventor: Stephen L. Zabriskie, Aurora, NY (US)

(21) Appl. No.: 12/622,841

(22) Filed: Nov. 20, 2009

(51) Int. Cl. B25B 13/00; B23P 19/04

(52) U.S. Cl. 81/125.1; 29/240

(57) ABSTRACT

A device for installing and removing light bulbs. The device preferably comprises a tubular or frustoconical body with a detachable ring positioned proximately to one of the terminal ends. The ring includes a flexible mesh material positioned in covering relation to the opening at the terminal end for frictionally engaging a light bulb of various sizes and shapes. The device can further incorporate an extension attachment for changing light bulbs positioned in elevated locations or means for convenient storage and transportation.

### BACKGROUND OF THE INVENTION

1. Field of Invention

The present invention relates to the field of gripping devices, and, more specifically, to a gripping device used to install and remove light bulbs.

2. Background of Art

Every day millions of light bulbs are sold around the world. The typical U.S. house, for example, has roughly fifty light bulb sockets, and that number is on the rise. These light bulbs are available in an exceptionally wide variety of shapes and sizes. With so many light bulbs there is a constant need to remove and replace bulbs that are no longer functional.

Removing a light bulb can be challenging. Some bulbs are located in hard to reach locations, including recessed floodlights, spotlights, and track lighting, among others. Other bulbs are too firmly engaged in the socket to remove by hand. Still others are cracked or otherwise damaged such that removing the bulb without assistance becomes impossible. Additionally, light bulbs that were actively in use when their useful life ended can be too hot to be removed without the assistance of a removal device.

Existing devices use a variety of means to effect removal and replacement of a light bulb. Some devices, for example, engage the surface of the bulb and mechanically create a vacuum to allow the user to twist the bulb. This method is typically limited to light bulbs of a certain size and/or shape, and requires batteries or electricity as a power source to create the vacuum. Other devices use suction cups to engage the surface of the bulb. These devices are also limited to light bulbs of a certain size and/or shape and require the use of force to activate the suction. Still other devices involve one or more steps to tighten components of the complex device around the bulb before it can be removed or replaced.

Consequently, there is a need for a simple removal device that does not require an external power source such as batteries or electricity. Additionally, there is a need for a simple removal device capable of interacting with light bulbs of a wide variety of shapes and sizes.

### SUMMARY OF THE INVENTION

It is a principal object and advantage of the present invention to provide a simple device to remove and install light bulbs.

It is an additional object and advantage of the present invention to provide a device capable of removing and installing light bulbs of different shapes and sizes.

It is a further object and advantage of the present invention to provide a simple human-powered device capable of removing and installing light bulbs without the use of an external power source.

Other objects and advantages of the present invention will in part be obvious, and in part appear hereinafter.

The present invention comprises a light bulb changer having a body formed from a tube. At either or both ends of the tube is a removeable ring containing a flexible mesh for frictionally engaging a light bulb. A user may remove or install a light bulb by engaging the bulb with the flexible mesh and then rotating the tube in the appropriate direction.

The device may further incorporate an attachment to one end of a pole for changing light bulbs positioned in elevated locations, or a harness for convenient storage and transportation of the device.

### BRIEF DESCRIPTION OF THE DRAWINGS

The present invention will be more fully understood and appreciated by reading the following Detailed Description in conjunction with the accompanying drawings, in which:

FIG. 1 is a side perspective view of a preferred embodiment of the device.

FIG. 2 is a front perspective view of a preferred embodiment of the device.

FIG. 3 is a rear perspective view of a preferred embodiment of the device.

FIG. 4A is a cross-sectional view of a preferred embodiment of the device.

FIG. 4B is a shaded cross-sectional view of a preferred embodiment of the device.

FIG. 5 is an exploded view of a preferred embodiment of the device.

FIG. 6A is a front view of the large ring and large mesh screen of a preferred embodiment of the device.

FIG. 6B is a front view of the small ring and small mesh screen of a preferred embodiment of the device.

### DETAILED DESCRIPTION OF THE INVENTION

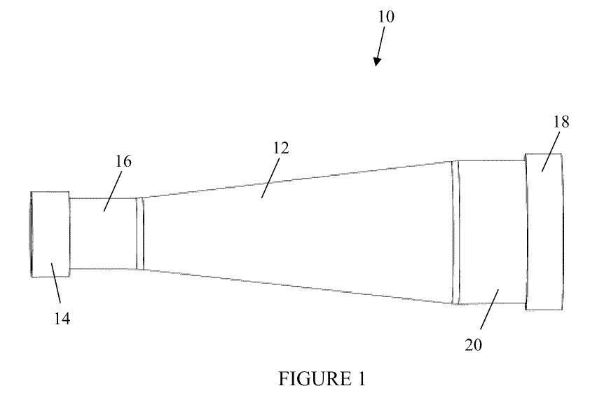

Referring now to the drawings, wherein like numerals refer to like parts throughout, there is seen in FIG. 1 a light bulb removal and installation device 10. Device 10 comprises a tubular body 12 that is preferably frustoconical, although it may be any geometric shape capable of effectuating the structural requirements for removing or installing a light bulb. The exterior of the body can also be textured, ribbed, or otherwise adapted to promote a tighter grip on the surface by the user's hand.

Device 10 further comprises a small ring 14 is removeably attached to the narrow end 16 of tubular body 12, and large ring 18 is removeably attached to a wide end 20 of tubular body 12. To effect removeable attachment to the ends of the tube, rings 14 and 18 can be snapped into place, screwed onto threads located on the ends, or affixed through any other known mechanism of removeable attachment.

Removeable rings 14 and 18 provides a number of different benefits. For example, once ring 14 or 18 is removed a wide variety of tools can be affixed to the end of tubular body 12. Device 10 may be placed on an extension pole and used to remove and install light bulbs that are otherwise difficult to reach. Alternatively, a basket mechanism can be affixed to one end of tubular body 12 and used to catch the light bulb, broken glass, or other debris as a light bulb is installed or removed. Rings 14 or 18 can also be permanently affixed to tubular body 12 by any means of permanent fixation, including being manufactured together with the tube in a single mold, gluing, or other types of mechanical fixation.

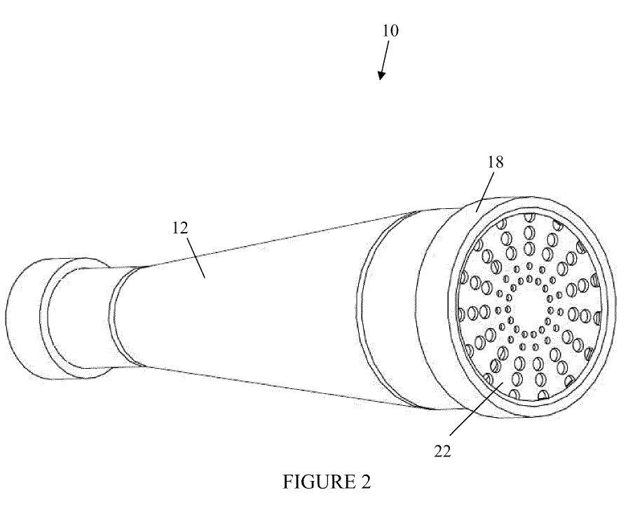

FIG. 2 is a front perspective view of device 10 with large ring 18 attached to the wide end of tubular body 12. The interior of large ring 18 comprises a flexible material 22 to engage the surface of a light bulb. Flexible material 22 may comprise a mesh or woven matrix made from a flexible or elastic polymer, such as a Contact Brand® cushioned shelf liner available from Kittrich Corporation of La Mirada, Calif.

In a preferred embodiment, device 10 functions by applying force to tube 12 such that flexible material 22 frictionally engages the surface of the light bulb. When a sufficient amount of force is applied through the tube, flexible material 12 deforms and wraps around the surface of the light bulb to create a tight grip for twisting the light bulb in either direction. If the target light bulb is broken, flexible material 22 can still frictionally engage any remaining surfaces on the light bulb to allow for removal.

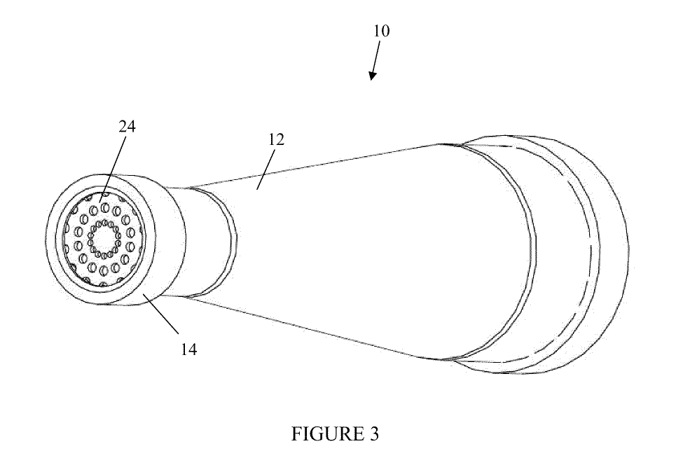

FIG. 3 is a front perspective view of device 10 with small ring 14 attached to the narrow end of tubular body 12. The interior of small ring 14 also comprises a flexible material 24 to engage the surface of a light bulb. In a preferred embodiment this end of the device is used to remove or install light bulbs of smaller size or shape. Flexible material 24 can be any of the materials used for flexible material 22. In another embodiment of the present invention, tubular body 12 can incorporate flexible material 22 and 24 directly into the ends of the tube rather than into the rings. In that embodiment, tubular body 12 lacks rings 14 and 18.

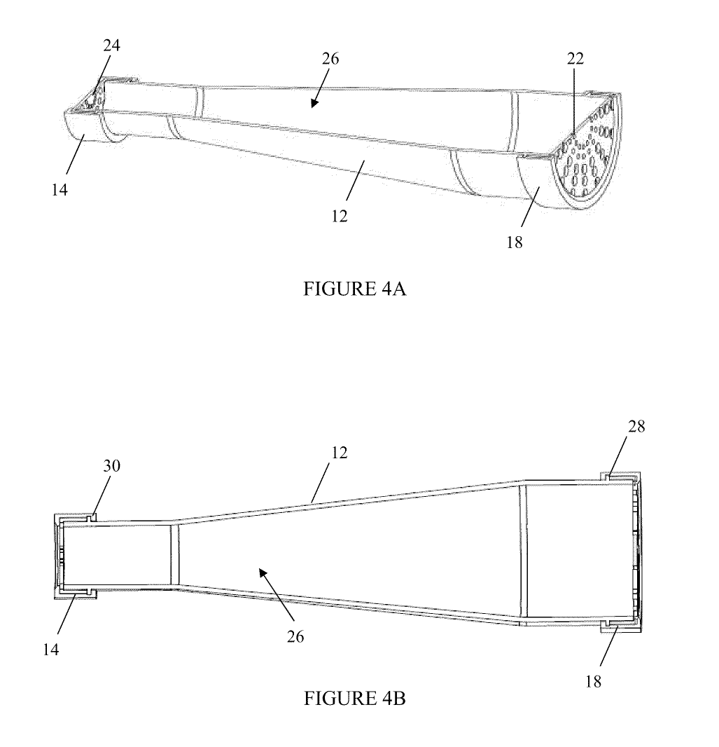

FIGS. 4A and 4B are cross-sectional views of device 10. In a preferred embodiment, tube 12 defines an interior cavity 26 which is hollow. Alternatively, the interior can be modified to meet the needs of the user. For example, the interior can be filled with a solid material or contain means for catching or abating hazardous chemicals or substances released by damaged light bulbs.

Referring to FIG. 4B, a preferred embodiment of the present invention comprises a method of affixing small ring 14 and large ring 18 to tubular body 12 where ridges 28 and 30 extend circumferentially around the exterior surface of tubular body 12. Each ring 14 and 18 snap engages with ridges 28 and 30, respectively, so that the ring is tightly but removeably attached to body 12. This mechanism of attachment will prevent the ring from turning or rotating around the body as the device is used to install or remove a light bulb. In another embodiment the small and large rings can also be permanently affixed to the body. All three components can also form a single, continuous device instead of three separate but interlocking components.

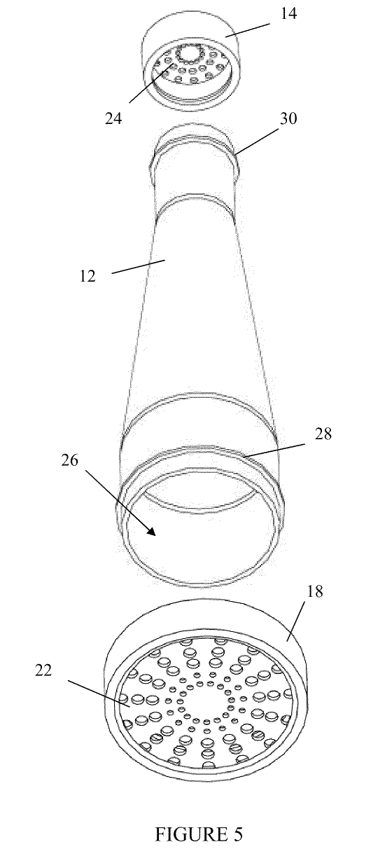

FIG. 5 is an exploded view of a preferred embodiment of the device, with small ring 14, large ring 18, and tubular body 12. The body defines cavity 26 and comprises a narrow end and a wide end. The narrow end comprises ridge 30 for engagement with the small ring, and the wide end of the body comprises ridge 28 for engagement with the large ring.

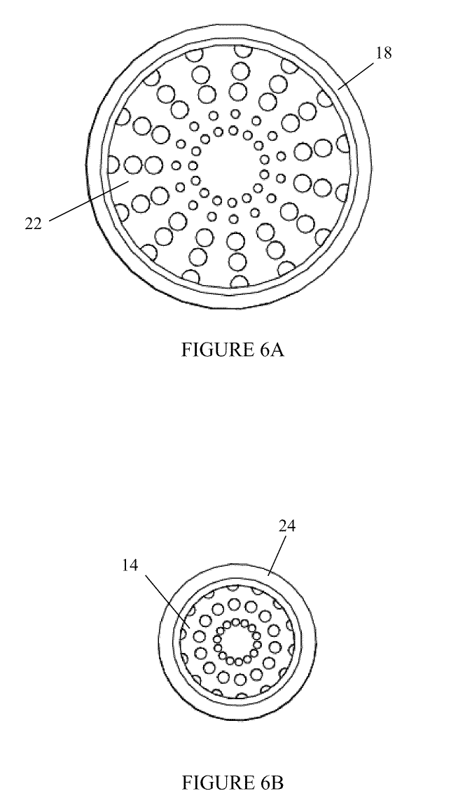

FIG. 6A is a front view of large ring 22 and flexible material 22, and FIG. 6B is a front view of small ring 14 and flexible material 24 of the device. In a preferred embodiment, flexible material 22 and 24 is an elastic mesh with a pattern of spaced holes. Alternatively, the material can be anything that provides elasticity while simultaneously providing sufficient strength to prevent rips or tears in the material. The material can also be textured to enhance the frictional engagement between the material and a light bulb. To promote brand recognition or customer personalization, the material can be colored or printed with a logo.

Device 10 can be further adapted for consumer needs. The device may comprise a pole-like extension or attachment that removeably engages one end of the frustoconical body to allow the user to change light bulbs positioned in elevated locations. To removeably engage the body, the consumer can remove small ring 14 or large ring 18 and affix the attachment with the same means used to affix the rings, including engagement with ridge 28 or ridge 30. When the extension is no longer needed, the user can disengage the attachment and reengage the ring. Alternatively, either end of tubular body 12 can comprise other permanent means for the rapid attachment and removal of accessories.

The device may further comprise means for convenient storage and transportation. Tubular body 12 can, for example, define a protrusion or hole to allow attachment of a rope, strap, or harness. Although the present invention has been described in connection with various embodiments, it should be understood that modifications, alterations, and additions can be made to the invention without departing from the scope of the invention as defined by the claims.

What is claimed is:

1. A device for installing and removing light bulbs, said device comprising:
a tube having first and second openings and a cavity extending therebetween; and
an elastic material disposed in covering relation to said first opening.

2. The device of claim 1, wherein said tube is generally frustoconical.

3. The device of claim 2, further comprising a second elastic material disposed in covering relation said second opening.

4. The device of claim 1, further comprising a ring positioned over said first opening.

5. The device of claim 4, wherein said first elastic material is disposed between said ring and said first opening.

6. The device of claim 5, further comprising a ridge extending circumferentially around said tube proximate to said first opening.

7. The device of claim 7, wherein said ring is frictionally engaged to said tube via said ridge.

8. The device of claim 7, further comprising a second ring positioned over said first opening.

9. The device of claim 8, wherein said second elastic material is disposed between said second ring and said second opening.

10. The device of claim 9, further comprising a second ridge extending circumferentially around said tube proximate to said second opening.

11. The device of claim 7, wherein said second ring is frictionally engaged to said tube via said second ridge.

12. A method of removing a light bulb, comprising the steps of:
positioning a tubular body including at least a first opening an a flexible material covering said opening proximately to said light bulb;
pressing said tubular body over said light bulb so that said flexible mesh frictionally engages said light bulb; and
rotating said tube to rotate said light bulb in a predetermined direction.

13. The method of claim 12, wherein said tubular body includes a ring positioned over said first opening to retain said flexible material in covering relation to said first opening.

14. The method of claim 13, further comprising a ridge extending circumferentially around said tubular body and in engagement with said first ring.
